(19) United States
(12) Patent Application Publication
(10) Pub. No.: US 2004/0061026 A1
(43) Pub. Date: Apr. 1, 2004

(54) Simple, forward-rolling canopy for small airplanes

(76) Inventor: Clifford Bernard Cordy JR., Reno, NV (US)

Correspondence Address: Dr. Clifford B. Cordy Jr., 6402 Mae Anne #20, Reno, NV, 89523, US

(21) Appl. No.: 10/259,914

(22) Filed: Sep. 30, 2002

(51) Int. Cl. B64C 1/10; B64D 7/00

(52) U.S. Cl. 244/121

(57) ABSTRACT

The inventions described here apply to the design of the canopy of a small airplane. The geometry of the joint between the canopy and fuselage is such that no water is allowed to enter the cockpit when flying in wet weather. The joint between the canopy and fuselage is not sealed. Small amounts of water can get thru the joint. This is carried away by a gravity operated rain gutter system before it enters any space in the fuselage occupied by people, instruments, or luggage.

This design that excludes water from the cockpit also provides guides that allow the canopy to be opened by rolling it forward on three small wheels in a tricycle arrangement. This system for opening the canopy is very simple, cheap, and light weight. The motion of the canopy as it closes allows a very simple, light weight, and exceptionally secure locking mechanism that engages dowel pins between the fuselage and canopy.

### RELATED APPLICATIONS

NONE

### FEDERALLY SPONSORED RESEARCH OR DEVELOPMENT

NONE

### Innovations to be Covered

A Rain disposal system

B Forward rolling canopy

C Canopy locking mechanism

### BACKGROUND

Using modern manufacturing processes and composite materials, it is practical to produce a joint between the canopy and fuselage of an airplane that leaks very little air or water, even without a compression seal between the two. The leakage of air into the cockpit is well below the maximum acceptable level for the comfort of the people in the airplane. Unfortunately, essentially no water is acceptable, either for the people or the radios and instruments. Practical manufacturing tolerances alone are not adequate to exclude water from the interior of the airplane when flying in wet weather.

Weather seals are bulky (generally causing a joint that produces noticeable air drag), and they wear out, so must be replaced occasionally. It is more desirable to have the rigid surfaces of the fuselage and canopy meet in such a way that the fit is snug (for better aerodynamics) and permanent (requiring no maintenance). The design of such a joint is described below.

There are an enormous variety of designs for opening the canopy. It is totally impractical to describe all of them here. I will mention the general classes. The simplest and lightest is to unlock the canopy and have your flight crew lift it off the plane and carry it away. This is also the most cumbersome, and is used only on special purpose airplanes. Other designs have the canopy hinge up from one side, hinge up from the front, hinge up from the rear, translate up and rearward, translate up and forward, or various arrangements having doors open and close against a fixed beam down the center of the canopy.

The side hinge is very simple, cheap, and lightweight. The disadvantages are: (1) everyone must enter and leave from one side of the airplane. (2) The longeron that forms the top edge of the fuselage at the canopy joint must be straight, or nearly so, at least for the span between the hinges. The sides of most airplanes are curved enough to make the use of side hinges difficult. (3) It would be even more difficult, generally impossible, to create a water resistant geometry for the canopy joint using a side hinge canopy. (4) When open, the upper edge of the canopy is very high and the canopy catches any side winds. Therefore, the hinges and braces must be much stronger than required by flight considerations.

ALL the other designs are more complicated (often much more complicated) and heavier (often MUCH heavier). Any design using doors requires very good rain seals. (Having a canopy implies a low wing airplane. Simple doors, as on a Cessna, are applicable only to high wing aircraft.) Any canopy that hinges open sticks up very high and is vulnerable to wind gusts when open. A canopy that translates back to open must move back almost the entire length of the canopy or it will sit above the seats and interfere with the entry and exit of the people. A forward translating canopy needs to move only about half the length of the canopy in order to clear the seats and provide easy access. Also, it is at least theoretically possible for the canopy to remain very close to the fuselage when fully open and at all times while being opened. This minimizes its vulnerability to wind gusts. Existing mechanisms for forward sliding canopies are very complex, expensive, and generally heavy.

### SUMMARY

This patent application describes a canopy /fuselage interface that prevents rain from entering the cockpit, first, by precise manufacture that allows only a minimal amount of rain to pass thru the joint between the canopy and the fuselage, and, second, by shaping that joint in such a way that any water that does get thru the joint will flow out of the airplane under the influence of gravity and not affect people or components inside the cabin. The canopy is opened using a very simple, cheap, lightweight system of three wheels. The design of the rainwater exclusion system provides a guide that keeps the canopy movement in the proper fore and aft direction. Thus, one simple piece is doing two independent jobs.

### BRIEF DESCRIPTION OF THE ILLUSTRATIONS

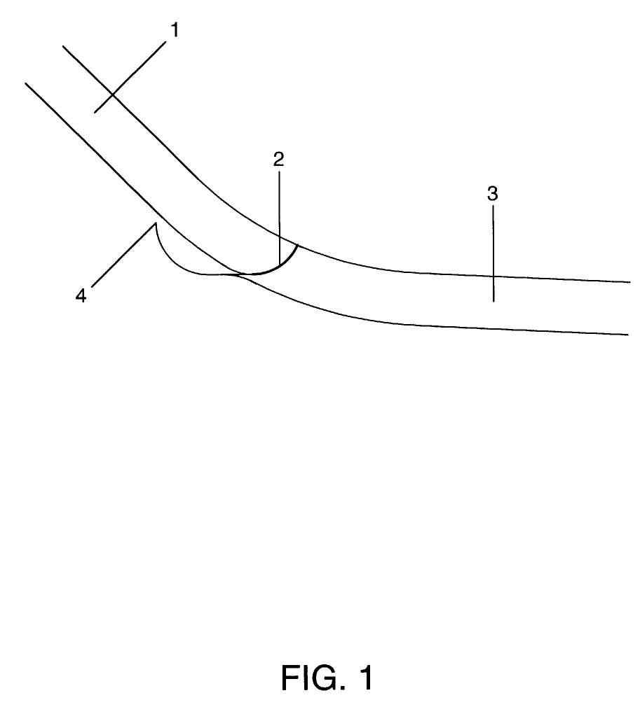

FIG. 1 is a cross section of the front of the canopy showing the joint with the fuselage and the channel that carries away rain water.

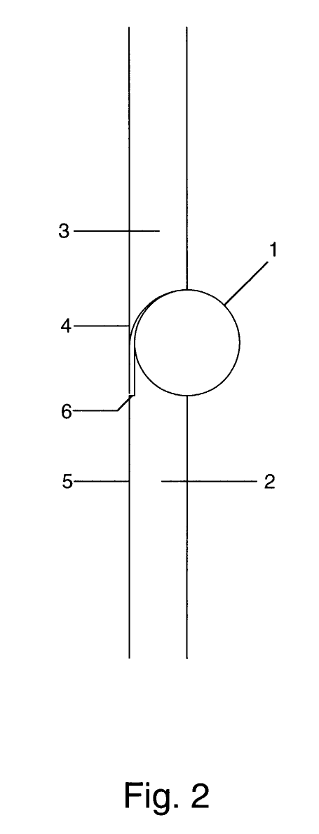

FIG. 2 is a cross section of the side of the canopy showing how it fits over the longeron at the top of the fuselage opening.

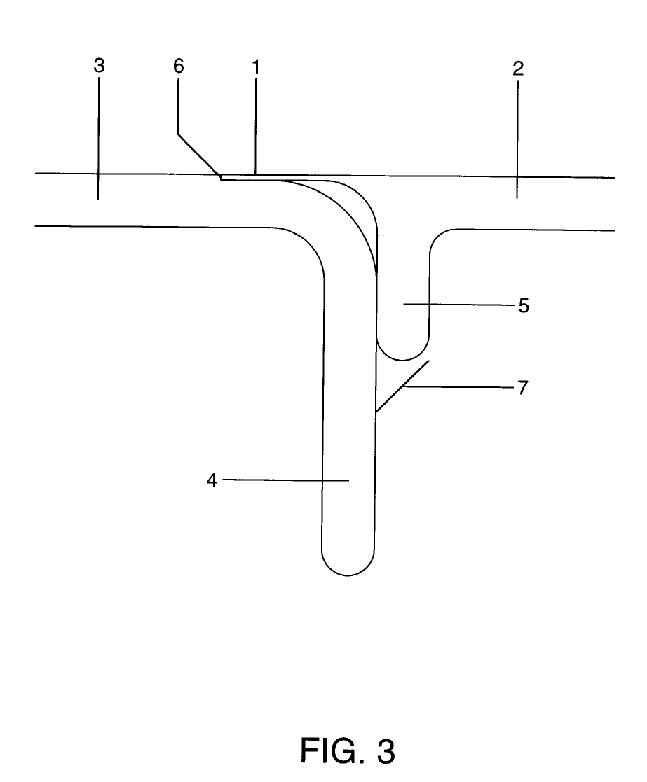

FIG. 3 is a cross section of the back of the canopy showing the joint with the fuselage.

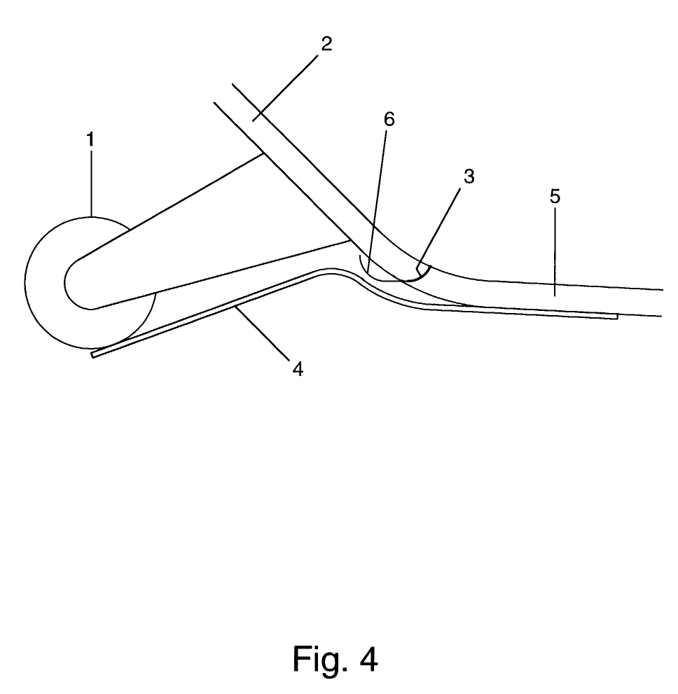

FIG. 4 shows the wheel at the front edge of the canopy and the track on which it rolls inside the cockpit.

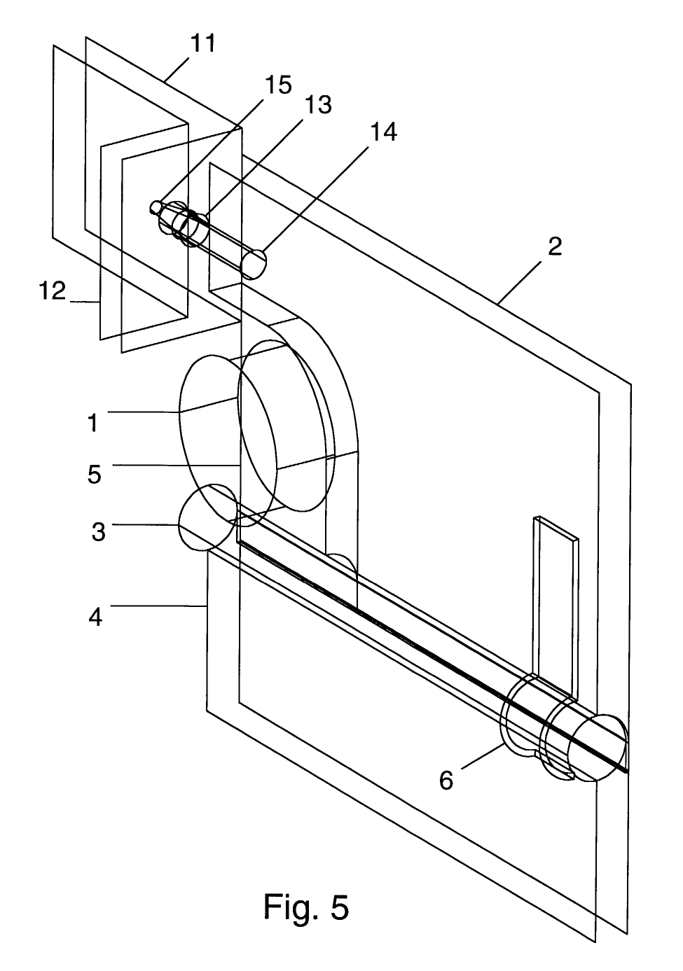

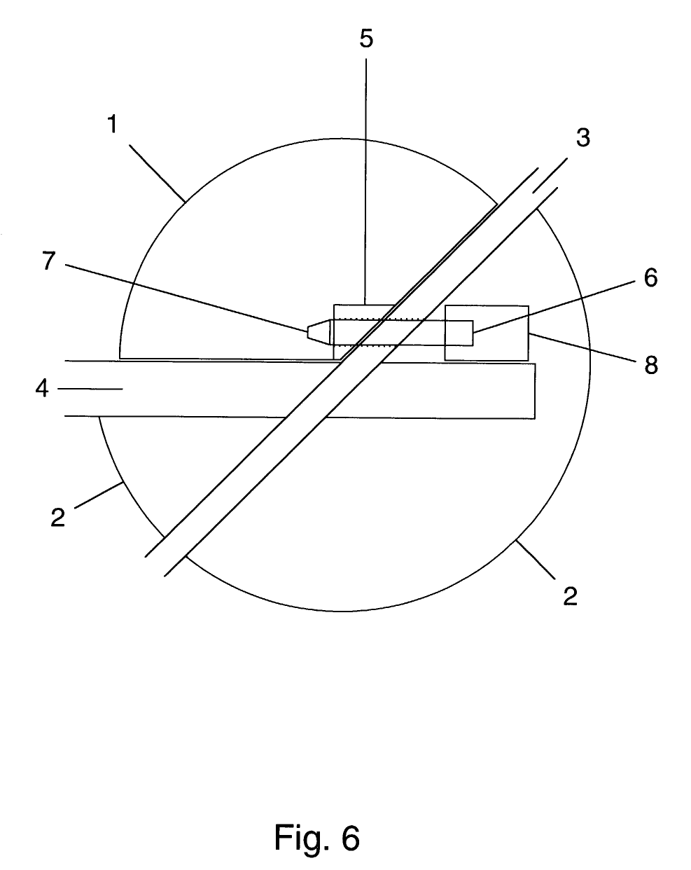

FIG. 5 shows a wheel at the back corner of the canopy, and a dowel for securing the canopy when it is closed FIG. 6 a dowel and actuating mechanism for securing the front of the canopy when it is closed.

### DETAILED DESCRIPTION OF THIS INVENTION

The Rain Gutter

The main source of water entering the cockpit is from the leading edge of the canopy. This is necessarily a high pressure point in the airflow over the airplane. With the best of tolerances, some water will be driven thru the crack between the front of the canopy and the fuselage. In a well designed, well built airplane, there is amazingly little water flow, but an occasional drop does come thru. The solution to this problem is to extend the fuselage a short distance under the canopy and up the inside. This provides a channel (rain gutter) that will carry the water to the sides of the airplane, where it can flow out thru a small passage over the longeron and under the edge of the canopy. A cross section of the joint at the leading edge of the canopy is shown in FIG. 1. The canopy (1) makes a reasonably tight joint (2) with the fuselage (3). With composite structures, the canopy and fuselage will have significant thickness, as shown. A functionally similar joint could be designed into a thin-skinned airplane. The inner surface of the fuselage (3) extends under the canopy (1), then up, to form the edge (4) of a water channel. The water that creeps thru the joint (2) cannot get over the edge (4) of the channel, even if there is a bit of air flow passing thru the joint. When a large enough drop of water has collected to overcome the effects of surface tension, it will flow within the channel to the sides of the airplane, and run overboard.

With the forward rolling canopy, to be described later, the sides of the canopy can extend down, outside of the longeron, as shown in FIG. 2. The longeron (1) forms the top of the fuselage (2) at the joint with the canopy (3). Again, both the fuselage and canopy usually have significant thickness, as shown, but this is not essential to this design. The longeron (1) is shown with a round cross section, but this is not necessary, either for the function of the longeron, the exclusion of rain water, or the operation of the forward rolling canopy. The outer surface (4) of the canopy (3) extends down a short distance (typically several mm), over the outside of the longeron (1). Ideally, the outer surface (5) of the fuselage (2) will have a small step (6) so the canopy (3), when closed over the fuselage (2), provides a smooth, aerodynamic surface. The canopy may also contain a longeron, but that is unimportant to this discussion. In most airplane designs, the outside air pressure at the lower edge of the canopy is neutral to very slightly negative. Thus, gravity is more than adequate to keep water out of this joint, even if it is not very snug.

In most airplane designs, the rear of the canopy is operating in a slightly negative pressure. Thus, there is an aerodynamic tendency to suck water from that joint toward the outside of the airplane. Generally it is sufficient to overlap the outer skin of the canopy over fuselage, as shown in FIG. 3. The outer skin (1) of the canopy (2) extends to the rear, over the fuselage (3). Typically the fuselage (3) will be stiffened by a bulkhead (4) just behind the canopy. The canopy may also be stiffened with a bulkhead (5). Neither bulkhead is necessary for this design to be implemented, nor is it required for the skin of the fuselage of canopy to have significant thickness. Again, a small step (6) in the fuselage will provide the best aerodynamic performance. If the fuselage design is such that the rear of the canopy is operating at a positive pressure, a rain gutter (7) can be added, similar to the situation shown in FIG. 1.

The Forward Rolling Canopy

Consider the canopy as a tricycle, one wheel at the center, forward edge, and one wheel at each rear corner. Inside the fuselage, there is a small ramp on which the front wheel rolls up, out of the cockpit, then along the top of the fuselage (and maybe the cowl). The rear wheels roll along the top of the longeron. This is extremely simple and, at first glance, impossibly unstable. The art is in the details.

FIG. 4. shows the the front wheel. A wheel (1) is mounted under the front of the canopy (2), several cm behind the leading edge (3) of the canopy. Any ordinary wheel will suffice. A ramp (4) is mounted to the fuselage (5) to provide a path for the wheel (1) when it is behind the fuselage (5). It is desirable, though not entirely necessary, for this ramp to have a bit of spring to lift the front canopy joint (3) above the level of the fuselage (5) when the canopy latches (not shown) are opened. For this to be effective, the spring travel of the ramp should be in the range of 1 cm (a very simple spring). Alternatively, a spring could be incorporated into the mount of the front wheel. FIG. 4 shows the canopy and ramp in the canopy-closed position. The front wheel (1) will get a bit of a bumpy ride as it rolls over the water channel (6), but the canopy weighs only a few kg and the bumps will not present a significant problem for opening the canopy. It is not entirely necessary for the ramp to exist at all. The pilot could lift the front of the canopy, move it forward a few cm, and set the wheel down on the top of the fuselage. This would not affect the function of this forward rolling canopy. The ramp is only a convenience.

FIG. 5 shows a rear wheel in trimetric view. The rear wheel (1) is mounted at the rear of the canopy (2). Any ordinary wheel will suffice. The wheels do not need to be vertical. The outside surface (5) of the canopy (2) extends down, outside the longeron (3) and fuselage (4) in order to exclude rain from the cockpit. Thus, the canopy can not move to either side, and the rear wheels (1) have no other option than to roll the length of the longeron (3). Also, since the front of the canopy is never more than a cm or so above the top of the forward part of the fuselage, the outside edges (5) of the canopy (2) extend below the longeron (3) for a considerable distance. This keeps the canopy pointed forward so the front wheel cannot roll significantly off the center of the fuselage. The rear wheels (1) should be mounted so they just touch the fuselage longeron (3) when the canopy is latched closed. When the front of the canopy (2) is lifted to start the forward movement, the entire canopy is lifted off the fuselage longeron (3). The canopy is supported on the three wheels and essentially no effort is required to roll the canopy fore and aft. One or more hooks (6) can be mounted to each side of the canopy (2) such that they extend under the longeron (3) of the fuselage (4). These will prevent the canopy from being knocked off the airplane by a person and will prevent the rear of the canopy from being lifted by the wind. If the hook (6) is located a reasonable distance ahead of the rear wheel (1), it will also prevent the front of the canopy from being lifted significantly by the wind. This spacing between the hook (6) and the back edge of the canopy also helps keep the front wheel on track. The canopy can roll forward for most of the length of the longeron, typically about a meter. This gives abundant room for loading and unloading luggage and people. The limit of forward movement of the canopy can be defined by hook (6), but another stop can be used if desired.

For structural considerations, there may be a longeron included along the sides of the canopy. This does not impact the rolling mechanism. The canopy longeron does not need to rest against (or be parallel to) the fuselage longeron. The canopy longeron can be entirely above the rear wheel and hook.

If the fuselage longerons are slightly closer together at the front than they are at the rear (2 or 3 mm), it will provide clearance between the fuselage ahead of the canopy and the edge of the canopy that extends below the fuselage longeron.

Almost any conventional canopy latch system will work with this canopy rolling mechanism. There is an innovative new latch system that is a natural for this canopy motion. Dowels are mounted on the back or the canopy. These mate into holes in the rear cockpit bulkhead at the back of the canopy as the canopy closes. The front of the canopy drops in behind the front cockpit bulkhead with movable dowels that can be inserted into the canopy with a latching mechanism. This provides an exceptionally secure latch that is very light weight. Both these bulkheads already exist in most airplane designs to provide sufficient strength.

Included in FIG. 5 is a small portion of the wall of the fuselage (11) and rear cockpit bulkhead (12). The rear cockpit bulkhead (12) contains a hole (13), sufficiently reinforced for strength and durability. A dowel (14) is mounted to the wall of the canopy (2) in such a position that it extends into the hole (13) in the rear cockpit bulkhead (12). The dowel (14) may be tapered (15) to facilitate alignment of the canopy (2) with the hole (13) in the rear cockpit bulkhead (12) as the canopy (2) rolls rearward to its closed position. It is obviously possible to build a functionally equivalent mechanism with dowels mounted to the rear cockpit bulkhead that mate to holes mounted on the canopy.

FIG. 6 shows a small section of the front corner of the canopy (1), with the adjacent areas of fuselage (2), front cockpit bulkhead (3), and longeron (4) which usually extends forward thru the front cockpit bulkhead (3). Mounted to the canopy (1) is a retainer (5) into which a dowel (6) is inserted to lock the canopy (1) closed. This retainer (5) can have many forms, including a hook, bracket, or block. The dowel (6) may insert into a hole or above a flange of the retainer (5). The end of the dowel may be tapered (7) to facilitate alignment between the canopy (1) and the fuselage (2). An actuating mechanism (8) of any convenient design inserts and retracts the dowel (6). It is obviously possible to build a functionally equivalent mechanism with dowels and actuating mechanism mounted to the canopy mating retainers in the front cockpit bulkhead. There are two significant advantages to the arrangement shown in FIG. 6. First, it is easy to link the actuating mechanisms at the two front corners of the canopy so both dowels can be controlled with a single action of the pilot. Second, practical actuating mechanisms are larger than the retainer. If the dowel and actuating mechanism were mounted to the canopy, the canopy would have to be raised higher before it could begin its forward motion.

Obviously, for this forward rolling system to work, the longerons must be straight, or nearly so, (at least when viewed from above), and they must be parallel, or nearly so, (at least when viewed from above), for at least for the length of travel of the rear wheels. Thus this method of opening the canopy partially suffers from the second disadvantage of the side hinged canopy (only partially because the longerons can be curved in the vertical plane). This may seem like a serious limitation on the aerodynamic performance of the fuselage. It is not as bad as it seems at first. It is possible to design a fuselage that is continuously curved in an aerodynamic shape in any horizontal section, any vertical cross section, or any section at any angle that contains the axis of thrust of the airplane, and still have straight, parallel longerons.

Consider the hyperbolic paraboloid. This is a three-dimensional surface. The intersection of this surface with ANY plane perpendicular to ANY of the three axes (x, y, and z) forms a curve that is either a parabola or hyperbola. Still the ENTIRE surface can be generated by a family of straight lines. Something similar is possible in an airplane. By prudently selecting the position of the straight, parallel longerons, the central part of a very aerodyanmic fuselage can be designed around them.

1 A forward opening airplane canopy comprising three wheels, one located centrally, near a front end of said canopy, two located at rear corners of said canopy wherein said canopy opens by rolling forward, said rear wheels rolling on a canopy longeron, said front wheel rolling on a top of a fuselage.

2 A forward opening canopy as described in claim 1 further comprising a ramp attached to said fuselage on which said forward wheel can roll up onto said fuselage.

3 A ramp as described in claim 2 wherein said ramp functions as a spring for lifting said front of said canopy prior to beginning its forward motion.

4 A forward opening canopy as described in claim 1, comprising an outside skin of said canopy extending outside and below a level of said canopy longeron to help guide said canopy in its forward motion.

5 A forward opening canopy as described in claim 1 further comprising guides mounted inside of said canopy, ahead of said rear wheels, said guides extending down beside an inner edge of said canopy longeron, said guides helping to guide the canopy in its forward motion.

6 A forward opening canopy as described in claim 1 further comprising hooks mounted inside of said canopy, ahead of said rear wheels, said hooks extending under an inner edge of said canopy longeron, said hooks preventing said canopy from lifting off said airplane.

7 An airplane canopy comprising a joint between said canopy and a fuselage of said plane said joint being shaped to exclude water from an interior of said airplane without needing a seal.

8 An airplane canopy as described in claim 7, wherein a front edge of said canopy sits in a channel, any water passing thru said joint being carried in said channel to sides of said fuselage and dumped overboard.

9 An airplane canopy as described in claim 7, wherein an outside skin of said canopy extends outside and below a level of a canopy longeron, thus excluding water from entering at said joint.

10 An airplane canopy as described in claim 7, wherein an outside skin of {said rear} of said canopy extends aft, over said fuselage, to exclude water from said joint.

11 An airplane canopy as described in claim 7, wherein a rear edge of said canopy sits in a channel, any water passing thru said joint being carried in said channel to sides of said fuselage and dumped overboard.

12 A canopy locking mechanism comprising dowels on a rear of a canopy that engage mating holes in a rear of a cockpit bulkhead as said canopy moves into its closed position

13 A canopy locking mechanism as in claim 12 further comprising dowels in a front portion of a cockpit bulkhead that are inserted into a front of a closed canopy by an actuating mechanism.

14 A canopy locking mechanism as in claim 12 further comprising dowels in a front portion of said canopy that are inserted into a front cockpit bulkhead by an actuating mechanism.

15 A canopy locking mechanism as in claim 12 comprising holes in a rear of a canopy that engage mating dowels mounted in a rear of a cockpit bulkhead as said canopy moves into its closed position

16 A canopy locking mechanism as in claim 15 further comprising dowels in a front portion of a cockpit bulkhead that are inserted into a front of a closed canopy by an actuating mechanism.

17 A canopy locking mechanism as in claim 15 further comprising dowels in a front portion of said canopy that are inserted into a front cockpit bulkhead by an actuating mechanism.
